(19) United States
(12) Patent Application Publication
(10) Pub. No.: US 2010/0217816 A1
(43) Pub. Date: Aug. 26, 2010

(54) VIDEO VOICEMAIL AND MENU SYSTEM

(75) Inventor: Vladimir Smelyansky, Glenview, IL (US)

Correspondence Address: Hanify & King Professional Corporation, 1055 Thomas Jefferson Street, NW, Suite 400, WASHINGTON, DC, 20007, US

(73) Assignee: XCAST LABS, INC., Northfield, IL (US)

(21) Appl. No.: 12/710,030

(22) Filed: Feb. 22, 2010

Related U.S. Application Data
(60) Provisional application No. 61/154,467, filed on Feb. 23, 2009.

(51) Int. Cl. G06F 15/16; H04M 11/00; H04N 7/14

(52) U.S. Cl. 709/206; 379/88.13; 348/14.01; 348/E07.077

(57) ABSTRACT

A method, system, and computer program product for receipt, storage, playback of video voicemail and a menu for controlling playback of voicemail and other video content provides enhanced features. A method for delivering messages may comprise storing a message including both audio and video, determining an audio and video capability of a device requesting delivery of the message, and transmitting either the audio and video or the audio only to the requesting device based on the determined audio and video capability of the requesting device.

### CROSS-REFERENCE TO RELATED APPLICATIONS

This application claims the benefit of Provisional Application No. 61/154,467, filed Feb. 23, 2009, the contents of which are incorporated herein in their entirety.

### BACKGROUND OF THE INVENTION

1. Field of the Invention

The present invention relates to a method, system, and computer program product for receipt, storage, playback of video voicemail and a menu for controlling playback of voicemail and other video content.

2. Description of the Related Art

Audio-only telephones now provide a large number of enhanced features, such as voicemail and audio menus for controlling access to voicemail systems and other audio content. However, video phones do not provide correspondingly enhanced features for handling video voicemail and video menus for controlling access to video voicemail systems and other video content. As video phones become increasingly popular, a need arises for such enhanced features for handling video voicemail and video menus for controlling access to video voicemail systems and other video content.

### SUMMARY OF THE INVENTION

A method, system, and computer program product for receipt, storage, playback of video voicemail and a menu for controlling playback of voicemail and other video content provides the needed enhanced features.

For example, a method for delivering messages may comprise storing a message including both audio and video, determining an audio and video capability of a device requesting delivery of the message, and transmitting either the audio and video or the audio only to the requesting device based on the determined audio and video capability of the requesting device. The requesting device may be an audio only telephone and the audio only may be transmitted to the requesting device. The requesting device may be a videophone and the both the audio and the video may be transmitted to the requesting device. The message may be transmitted in an email, a notification of the message may be transmitted in an email, or a link that provides the capability to retrieve the message may be transmitted in an email.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of block diagram of a network system in which the present invention may be implemented.

FIG. 2 is an exemplary flow diagram of a process of emergency message broadcasting.

FIG. 3 is an exemplary block diagram of a videophone with a video menu.

FIG. 4 is an exemplary block diagram of a computer system, such as a video server, in which the present invention may be implemented.

### DETAILED DESCRIPTION OF THE INVENTION

A method, system, and computer program product for receipt, storage, playback of video voicemail and a menu for controlling playback of voicemail and other video content provides the needed enhanced features. Video voicemail features provide the capability for a caller to leave a video message if a video call is not answered. The message may be retrieved from an audio-only phone, with only the audio portion played, from a video phone as a video clip, and/or forwarded to email as a video clip or audio portion only. In addition, a call from a videophone may be directed to an application that provides the capability to play a number of video clips. Navigation from one clip to another is provided to the user by pressing different keys on the numeric keypad of the videophone. For example, a videophone in a hotel room may allow a guest to dial a number and receive video clips describing hotel offerings. The technology is also applicable to provide video on demand or video broadcast, which may replace existing cable services.

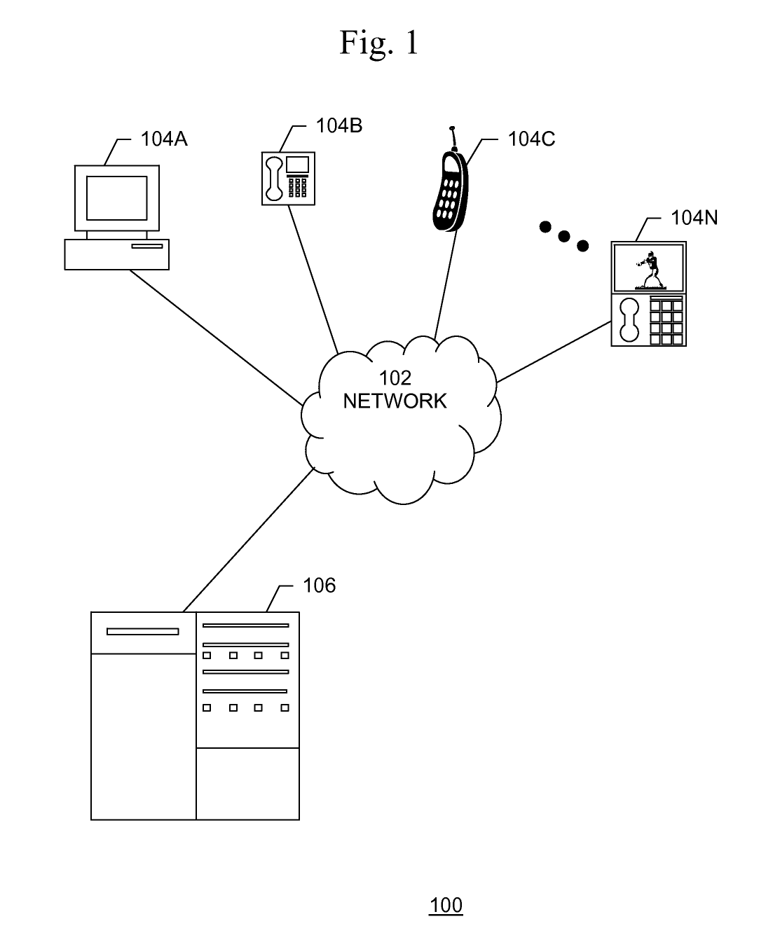

As an example, such features may be provided in a network system 100, such as that shown in FIG. 1. FIG. 1 shows a network 102, a plurality of telephone devices 104A-N, and a video server 106. Network 102 typically is, or includes the Internet, but may include any communications network that is now in service or which may be developed in the future. Such a network may include one or more public or private communications networks, such as the Internet, wired or wireless telephone networks, wired or wireless data networks, local area networks, etc. End user devices 104A-N include any device capable of transmitting audio and/or video to an end user, such as a softphone running on a computer system 104A, an audio-only telephone 104B, such as a PSTN or IP phone, a mobile smartphone 104C, and a wired videophone 104N, such as an IP videophone. Video server 106 is a server computer system that manages and delivers video or voice only mail to appropriate user/device combinations.

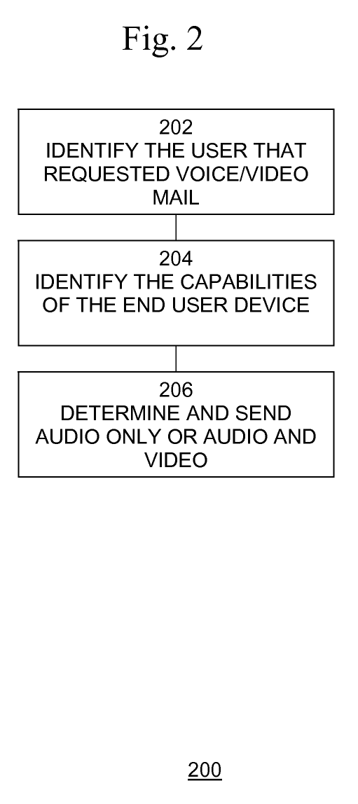

An exemplary flow diagram of a process 200 of retrieving video voicemail is shown in FIG. 2. It is best viewed in conjunction with FIG. 1. Process 200 begins with step 202, in which video server 106 identifies the user that has requested voice/video mail. For example, for calls coming from typical IP videophone, regular SIP authentication may be used. In step 204, video server 106 identifies the capabilities of the end user device 104A-N of the user requesting the voice/video mail. For example, such capabilities may be described as the SDP part of a SIP request, such as:

v=0
o=middle 3885742 102 IN IP4 38.102.250.16
s=session
c=IN IP4 38.102.250.16
t=0 0
m=audio 43638 RTP/AVP 0 8 18 4 3 101
a=rtpmap:0 PCMU/8000
a=rtpmap:8 PCMA/8000
a=rtpmap:18 G729/8000
a=rtpmap:4 G723/8000
a=rtpmap:3 GSM/8000
a=rtpmap:101 telephone-event/8000
a=fmtp:101 0-16
a=ptime:20

In addition to obtaining the inherent capabilities of the end user device 104A-N, an end user may be provided with the option select audio only messaging on an end user device that is capable of handling video. For example a smart phone can handle video, but the end user may not want to wait for a long load time over a cellular network.

In step 206, based on the identified capabilities of the end user device 104A-N, video server 106 determines if the end user device 104A-N is capable of receiving video, and transmits an audio only or audio/video stream as appropriate. In order to do this, messages must be stored in a format or formats capable of supplying both an audio/video stream and an audio only stream. For example, a message may be stored as an audio/video stream and an audio only stream, so that either an audio/video stream or an audio only stream may be directly supplied. Alternatively, a message may be stored as an audio only stream and a video only stream. This option allows an audio only stream to be directly supplied and an audio/video stream to be supplied as a combination of the audio and video streams. As another alternative, a message may be stored as an audio/video stream. This option allows an audio/video stream to be directly supplied and an audio only stream to be supplied by extracting the audio stream from the audio/video stream. All of the messages may be stored with the same stream format, or more than one stream format may be used, with the addition of the appropriate stream extraction/combination software. The various messages may be stored in a database or directly on the file system of video server 106.

Additionally, video voicemail may be sent to an end user over email. For example, the video voicemail message may attached to an email as an mp3 of a way file, for audio only messages, or as an H.264 file for audio/video messages. The email may then be transmitted using a standard email application. For example, the email may be stored in a temporary location, the library function mpack may be invoked to send the email, and the email may be deleted from the temporary location after it is sent.

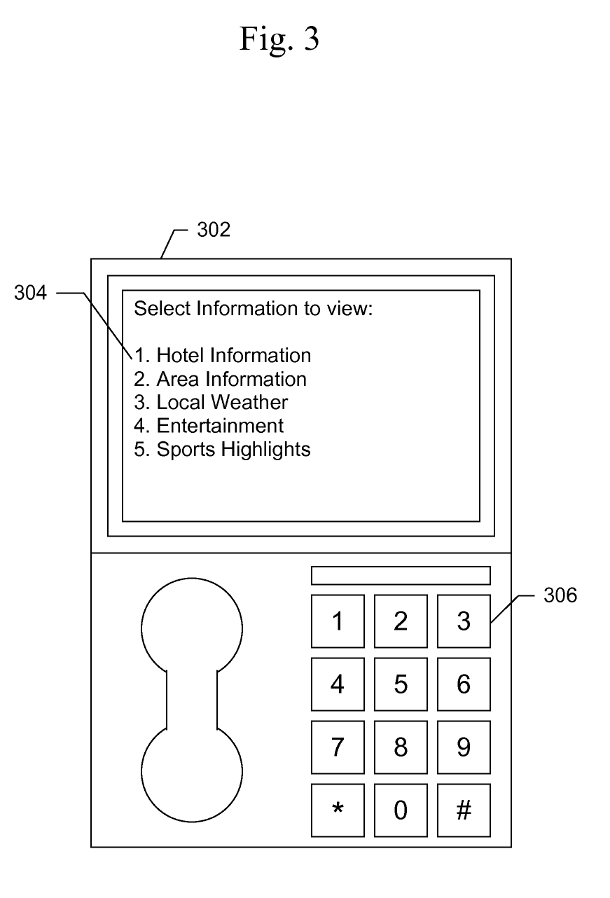

An exemplary block diagram of a videophone 302 with a video menu is shown in FIG. 3. Videophone 302 includes display 304 and a plurality of keys 306. A call from videophone 302 may be directed to an application that provides the capability to play a number of video clips. For example, the application may display a menu of available video clips on display 304. Navigation from one clip to another is provided to the user by pressing different keys 306 on the numeric keypad of the videophone. For example, a videophone in a hotel room may allow a guest to dial a number and receive video clips describing hotel offerings. The technology is also applicable to provide video on demand or video broadcast, which may replace existing cable services.

Videophone 302 with a video menu may be used to provide additional features. For example, when people with hearing disabilities call to a third party PBX, or other interactive voice response (IVR) system, they may have to navigate the system using a menu. Conventional systems provide only audio menus. However, the new technology described herein may be used to provide video menus in such a situation. For example, video prompts may be implemented as SIP video phone compatible video clips which are stored similarly to the way conventional systems store audio prompts. Both the audio and video prompts may be provided to the user, when the end user device has been identified as video capable, such as based on the SDP, as described above. For example, the audio prompt may play a message “press one for hotel information”, while the video prompt may display similar information, as shown in FIG. 3.

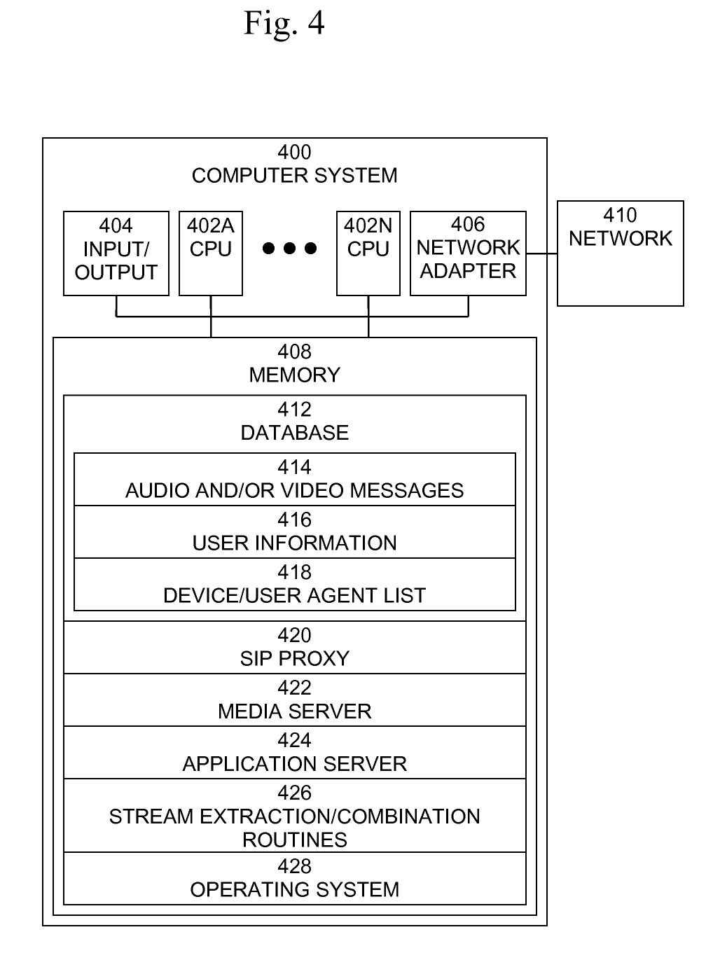

An exemplary block diagram of a computer system 400, such as a video server, is shown in FIG. 4. System 400 is typically a programmed general-purpose computer system, such as a personal computer, workstation, server system, and minicomputer or mainframe computer. System 400 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which System 400 is implemented as a single multi-processor computer system, in which multiple processors 402A-402N share system resources, such as memory 408, input/output circuitry 404, and network adapter 406. However, the present invention also contemplates embodiments in which system 400 is implemented as a plurality of networked computer systems, which may be single-processor computer systems, multi-processor computer systems, or a mix thereof.

Input/output circuitry 404 provides the capability to input data to, or output data from, database/system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces device 400 with network 410. Network 410 includes any communications network that is now in service or which may be developed in the future. Such a network may include one or more public or private communications networks, such as the Internet, wired or wireless telephone networks, wired or wireless data networks, local area networks, etc.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface, or Serial AT Attachment (SATA), or a variation or enhancement thereof.

The contents of memory 408 varies depending upon the function that system 400 is programmed to perform. For example, where system 400 is a video server, memory 408 includes database 412, which includes audio and/or video messages 414, user information 416, and device/user agent list 418, SIP proxy 420, media server 422, application server 424, stream extraction/combination routines 426, and operating system 428. Database 412 is a standard or proprietary database management system, which stores the information needed to provide the video voicemail and video menu features. Audio and/or video messages 414 include messages and/or video voicemail that may be transmitted to end user devices. User information 416 includes information about users and/or end user devices, such as user and/or device credentials. For example, such information may include voicemail user names/extension numbers and password and/or PINs. Device/user agent list 418 includes listings of end user devices and/or agents of such devices, including information about the capabilities of such devices. SIP proxy 420 is responsible for registration/authorization of end user devices and communication with the end user devices. Application server 424 determines what type of mail (audio/video or audio only) is to be sent based on a device's SIP user-agent or end user request. Media server 422 is responsible for transmission of the audio and/or video streams to the end user devices. Stream extraction/combination routines are responsible for extracting audio and/or combining audio and video so as to provide a stream appropriate to the capabilities of an end user device. Operating system 426 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable storage media include, floppy disks, hard disk drives, CD-ROMs, DVDROMs, RAM, flash memory, etc.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for delivering messages comprising:
storing a message including both audio and video;
determining an audio and video capability of a device requesting delivery of the message; and
transmitting either the audio and video or the audio only to the requesting device based on the determined audio and video capability of the requesting device.

2. The method of claim 1, wherein the requesting device is an audio only telephone and the audio only is transmitted to the requesting device.

3. The method of claim 1, wherein the requesting device is a videophone and the both the audio and the video are transmitted to the requesting device.

4. The method of claim 1, further comprising transmitting the message in an email.

5. The method of claim 1, further comprising transmitting in an email a notification of the message.

6. The method of claim 1, further comprising transmitting in an email a link that provides the capability to retrieve the message.

7. A computer program product for delivering messages comprising a computer readable storage medium and computer program instructions, recorded on the computer readable medium and executable by a processor, for performing the steps of:
storing a message including both audio and video;
determining an audio and video capability of a device requesting delivery of the message; and
transmitting either the audio and video or the audio only to the requesting device based on the determined audio and video capability of the requesting device.

8. The computer program product of claim 7, wherein the requesting device is an audio only telephone and the audio only is transmitted to the requesting device.

9. The computer program product of claim 7, wherein the requesting device is a videophone and the both the audio and the video are transmitted to the requesting device.

10. The computer program product of claim 7, further comprising the step of transmitting the message in an email.

11. The computer program product of claim 7, further comprising the step of transmitting in an email a notification of the message.

12. The computer program product of claim 7, further comprising the step of transmitting in an email a link that provides the capability to retrieve the message.

13. A system for delivering messages comprising a processor operable to execute computer program instructions, a memory operable to store computer program instructions executable by the processor, and computer program instructions stored in the memory and executable to perform the steps of:
storing a message including both audio and video;
determining an audio and video capability of a device requesting delivery of the message; and
transmitting either the audio and video or the audio only to the requesting device based on the determined audio and video capability of the requesting device.

14. The system of claim 13, wherein the requesting device is an audio only telephone and the audio only is transmitted to the requesting device.

15. The system of claim 13, wherein the requesting device is a videophone and the both the audio and the video are transmitted to the requesting device.

16. The system of claim 13, further comprising the step of transmitting the message in an email.

17. The system of claim 13, further comprising the step of transmitting in an email a notification of the message.

18. The system of claim 13, further comprising the step of transmitting in an email a link that provides the capability to retrieve the message.
